(19) United States
(12) Patent Application Publication
(10) Pub. No.: US 2022/0092879 A1
(43) Pub. Date: Mar. 24, 2022

(54) MATCHING OF FACE OR FACIAL IMAGE WITH A FACIAL IMAGE COMPRISED OF A PATTERN OF PERFORATIONS

(71) Applicant: ASSA ABLOY AB, Stockholm (SE)

(72) Inventors: Joseph Bernard Pearson, Cedar Park, TX (US); Robert Anthony Haslam, Mid Levels (HK)

(21) Appl. No.: 17/310,172

(22) PCT Filed: Feb. 7, 2020
(86) PCT No.: PCT/EP2020/053114

§ 371 Date: Jul. 23, 2021

Related U.S. Application Data
(60) Provisional application No. 62/802,409, filed on Feb. 7, 2019.

(51) Int. Cl. G06V 40/16; G06K 7/14; G06V 30/413

(52) U.S. Cl. CPC G06V 40/172; G06V 30/413; G06K 7/1417; G06V 40/166

(57) ABSTRACT

A method for identity verification. The method may include receiving an image of an identification document at an electronic device and identifying a first facial image therein. The first facial image may be an image resulting from a pattern of perforations formed in a substrate of the identification document. The method may further include receiving a presentation of a second image at the electronic device and identifying a second facial image therein. The first facial image and the second facial image may be compared by the electronic device, and an indicator of the confidence level that the first facial image and second facial image are of a same face may be provided.

### TECHNICAL FIELD

The present disclosure relates to novel and advantageous systems and methods for matching facial images or other representations of a face. Particularly, the present disclosure relates to novel and advantageous systems and methods for matching a face of a person or facial image thereof against a facial image comprised of a pattern of perforations.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for identity verification. The method may include receiving an image of an identification document at an electronic device and identifying a first facial image therein. The first facial image may be an image resulting from a pattern of perforations formed in a substrate of the identification document. The method may further include receiving a presentation of a second image at the electronic device and identifying a second facial image therein. The first facial image and the second facial image may be compared by the electronic device, and an indicator of the confidence level that the first facial image and second facial image are of a same face may be provided.

The present disclosure, in one or more embodiments, also relates to a method for identity verification including receiving an image of an identification document at an electronic device and identifying a first facial image and a second facial image in the image of the identification document. The first facial image may result from a pattern of perforations formed in a substrate of the identification document. The method may further include comparing the first facial image and the second facial image. An indicator of a confidence level that the first facial image and second facial image are of a same face may be provided.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the scope of the present disclosure. Accordingly, the drawings and detailed description are to be regarded as illustrative in nature and not restrictive.

### BRIEF DESCRIPTION OF THE DRAWINGS

FIG. 1 illustrates a system for matching facial images or other representations of a face according to an embodiment of the present disclosure;

FIG. 2 illustrates an electronic device according to an embodiment of the present disclosure and displaying first and second facial images;

FIG. 3 is a flowchart of a method for matching facial images or other representations of a face according to an embodiment of the present disclosure; and

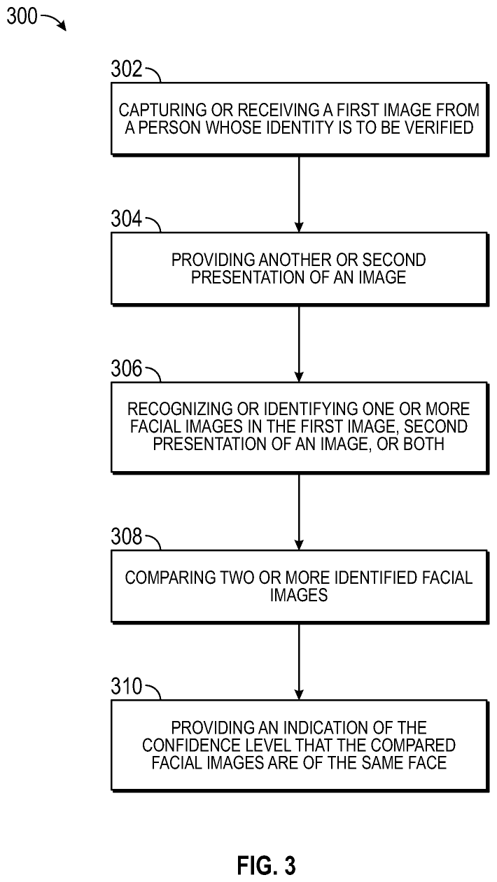

FIG. 4 illustrates a block diagram schematic of various example components of an example machine that may be used as, for example, an electronic device.

### DETAILED DESCRIPTION

The present disclosure relates to novel and advantageous systems and methods for matching facial images or other representations of a face. Particularly, the present disclosure relates to novel and advantageous systems and methods for matching a face of a person or facial image thereof against a facial image comprised of a pattern of perforations.

In general, the various embodiments of the present disclosure utilize facial recognition technology to match a facial image comprised of a pattern of perforations against another presentation of a face. The various embodiments may be used in the field to, for example, verify the identity of an individual presenting an identification document, such as an ID card, having the facial image comprised of a pattern of perforations formed therein.

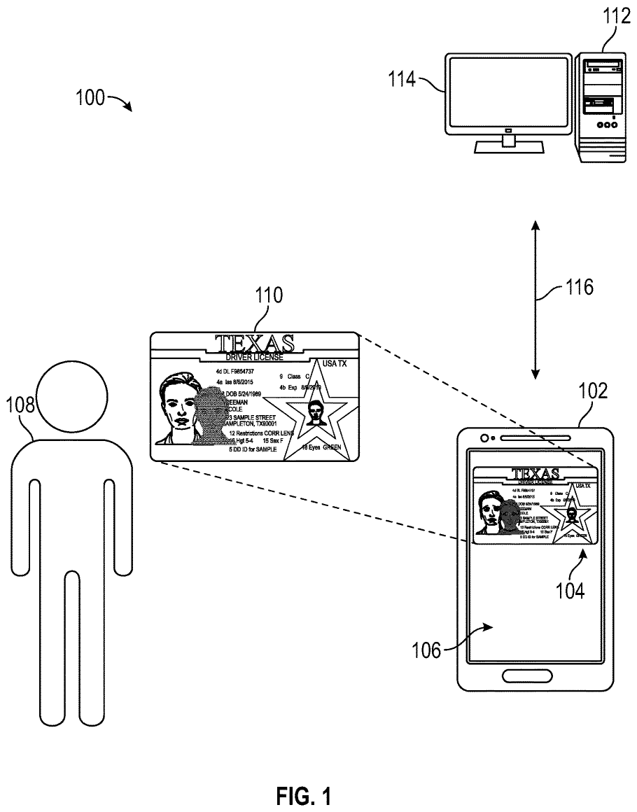

In one embodiment of the present disclosure, illustrated in FIG. 1, a system 100 may include an electronic device 102 with the capability to capture images or video, such as via a camera feature of the electronic device, or otherwise receive a still or video image 104, such as by scanning the image or receiving or downloading the image through other electronic means or via other communication means, like email, text, etc. In still other embodiments, the electronic device 102 can include the capability to capture images via a live feed. The electronic device 102 may further have the capability to display a received image 104 or live feed on a display 106. The electronic device 102 may be a mobile device, such as a mobile phone or smartphone, a tablet device, or another suitable portable or handheld device. In some embodiments, electronic device 102 may be a substantially stationary device of the kind not typically intended for convenient transportation, such as a personal computer or other similar end user or terminal device.

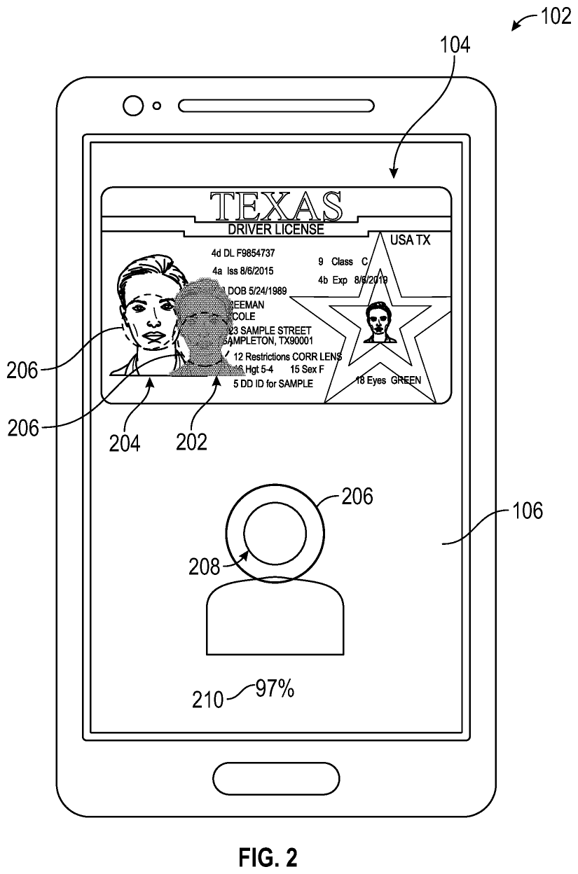

As illustrated in the system 100 of FIG. 1, a person 108, whose identity is to be verified, may present an identification document 110 to the electronic device 102. The identification document 110 may be provided in any suitable format acceptable for receipt or capture by the electronic device 102, such as but not limited to, a credential (such as a passport, driver's license, employee badge, or other identification document), a digital or printed still photograph or other image, or a video. As illustrated in better detail in FIG. 2, the identification document 110 could include at least one facial image 202, 204 printed thereon or embedded therein, for example, by laser engraving, laser personalization, or similar methodology. The electronic device 102 may include hardware and/or software providing facial recognition capability for identifying one or more face or facial images 202, 204 of a received image 104, such as the identification document 110. The electronic device 102 may optionally display the image along with one or more indicators 206 identifying any recognized facial images on the display 106. The facial recognition hardware and/or software of the present disclosure may be of the type, or similar to the type, used on mobile camera phone devices to identify a face or multiple faces on a display of the device prior to and/or subsequent to the taking of a picture with the camera. However, any suitable facial recognition hardware and/or software may be used, and in some embodiments, may be adapted or modified for use in the system 100 and for the purposes described herein.

In one embodiment, at least one facial image 202 captured by the electronic device 102 is an image on the identification document 110 resulting from a pattern of perforations formed on or in the identification document. One example of such type of image comprised of a pattern of laser perforations formed in a substrate is ImagePerf®, developed by IAI Industrial Systems BV, and is described in detail in PCT Publ. No. WO 00/43216, titled “Security Document with a Perforation Pattern,” and in European Patent Appl. No. 18188521, titled “Forge-Proof Document,” each of which is hereby incorporated by reference herein in its entirety. In general, and not intended to be limiting on the scope of incorporated subject matter from the above-identified reference, the identification document 110 may include a security feature in the form of a laser perforation pattern which displays grey tones when viewed against a bright or lighted background. The identification document 110 may be manufactured from a material which transmits light to a limited extent, and at least some of the perforations forming part of the perforation pattern extend over only a part of the thickness of the identification document at the position of the perforation while the thickness of the remaining part of the document at the position of the perforation is modulated in accordance with the image to be displayed. In additional embodiments, at least some of the perforations forming part of the perforation pattern may extend at an angle differing from 90° relative to the main plane of the identification document 110. In some embodiments, augmentation, transformation, or other alteration or editing of the captured image 202 resulting from the pattern of perforations formed in a substrate may need to be performed in order to prepare the captured image 202 for comparison with one or more other images, described in further detail below.

The electronic device 102 may also include hardware and/or software for comparing one image against another in order to determine whether the images substantially match or whether they differ in one or more significant respects. As illustrated in FIG. 2, in particular, the electronic device 102 may include hardware and/or software for comparing a first facial image 202 identified in the received image 104 against one or more other or second presentations of a face or facial image, e.g., 204, 208, in order to determine whether the first facial image substantially matches the one or more second presentations of a face or facial image or whether they differ in one or more significant respects. In one embodiment, another or second presentation of a facial image may be another facial image 204 on the identification document 110 itself, such as but not limited to, a printed photograph of a facial image of the type conventionally used on identification devices, such as passports, driver's licenses, employee badges, etc. Alternatively or additionally, another or second presentation of a facial image may be a photograph or live feed 208 of the person 108 presenting the identification document 110. In one embodiment, where multiple facial images are recognized by the electronic device 102, and optionally identified with indicators 206, a user of the electronic device may select which facial image to designate the first facial image, e.g., 202, and/or which facial image or images to designate a second presentation of a facial image, e.g., 204, 208. In some embodiments, a selection may be made simply by touching the screen at the location of, or otherwise selecting with a suitable input device, the indicator 206 corresponding to the desired facial image. In other embodiments, a selection of which facial image to designate the first facial image and/or which facial image or images to designate a second presentation of a facial image may be automatically determined by the electronic device 102. Automatic selection may be based on any number or combination of suitable factors that may assist the electronic device 102 in determining which image should be designated the first facial image and/or which facial image or images should be designated a second presentation of a facial image. Such factors may include, but are not limited to, the location of one or more images on the identification document 110, the location or one or more images on the display 106 of the electronic device, metadata corresponding to one or more images, algorithms programmed on or provided to the electronic device, the type of a given image, the source of a given image, the time of capture or receipt of a given image, etc. Use of the terms “automatically” or “automatic” here, and throughout the specification, includes embodiments where performance of a specified function or task may be completed without, or substantially without, user or human intervention.

In addition to the foregoing embodiments, and more generally, another or second presentation of a facial image may be any suitable image received by the electronic device from any suitable source. For example, in some embodiments, the person 108 may provide a second document, such as but not limited to another credential device, comprising another facial image, which when captured or received by the electronic device 102, may additionally or alternatively be used as another or second presentation of a facial image. In another embodiment, some identification documents have a processing chip and radio-frequency identification (RFID) element that contain certain biometric information about the proper owner of the identification document. The biometric information could include an image of the proper owner. As such, an image, as received from the identification document via radio frequency or near field communication, for example, may be provided as another or second presentation of a facial image. In still other embodiments, the second document can come from any suitable source other than the person 108. For example, in one embodiment, illustrated in FIG. 1, the system 100 may include a database 112 storing one or more facial images of one or more people. The database 112 may also include any other suitable information relating to the facial images, such as but not limited to, identification information for the person corresponding to each facial image. In one embodiment, the database 112 may be part of the electronic device 102. In other embodiments, the database 112 may be remote from the electronic device 102, and the electronic device may be communicatively coupled, directly or indirectly through a server 114 or similar device, with the database via a suitable communication channel 116, such as but not limited to, a wired or wireless local area network (LAN) or wide area network (WAN), such as the Internet, a cellular network, a radio frequency (RF) communication channel, or a Bluetooth or BLE communication channel.

In some embodiments, the server 114 may include the capability to capture one or more images or video, such as via a camera feature of the server or via one or more cameras communicatively coupled with the server, or otherwise receive still or video images, such as by scanning the images or receiving or downloading the images through other electronic means or via other communication means, like email, text, etc. The server 114 may provide one or more of such images to the electronic device 102 via the communication channel 116 for use as the first facial image and/or second presentation of a facial image, as described above.

At an even more general level, any and all of the components and functions of the electronic device 102 and server 114 described herein may be entirely located and performed on just a single device, such as either the electronic device or the server, or may be distributed amongst and collectively performed by multiple local and/or remote devices linked through a communications network, such as by a combination of the electronic device and the server or any other suitable device operatively or communicatively coupled with the electronic device. For example, any functionality of electronic device 102 described herein may additionally or alternatively be provided by, or performed at, another operatively or communicatively coupled device or combination of devices, such as one or more servers 114. Likewise, any functionality of server 114 described herein may additionally or alternatively be provided by, or performed at, another operatively or communicatively coupled device or combination of devices, such as electronic device 102 or other additional servers 114. For example, the hardware/software or functionality for any of i) capturing images or video, ii) identifying one or more face or facial images of a received image (e.g., facial recognition), iii) displaying images, iv) comparing images, v) generating, decoding, comparing, and/or using digital, encoded, or transformed representations of facial images (see below), and/or vi) providing an indication of whether or how well the compared images match, may be provided entirely by electronic device 102, entirely by one or more servers 114, or by any combination of electronic device 102 and one or more servers 114. For yet another example, functionality for comparing images may be provided by or at server 114 with results of the comparison being provided back to electronic device 102.

In some embodiments, a second presentation of a facial image may be a digital, encoded, or transformed representation of a facial image. For example, a second presentation of a facial image could be a two-dimensional barcode encoding a person's facial image. As with embodiments previously described, such a digital, encoded, or transformed representation of a facial image may be provided by any source, including by the person 108, by database 112, or any other suitable source. The hardware and/or software for comparing one image against another in order to determine whether the images substantially match or whether they differ in one or more significant respects, referenced above, may further encode the first facial image into a two-dimensional barcode for comparison with the two-dimensional barcode provided as the second presentation of a facial image. Alternatively, the hardware and/or software for comparing one image against another may decode the two-dimensional barcode provided as the second presentation of a facial image for comparison with the first facial image. As yet another alternative, the hardware and/or software for comparing one image against another may encode or decode each of the first facial image and the two-dimensional barcode provided as the second presentation of a facial image into a suitable third format for comparison of the images in the third format.

In one embodiment, upon comparing the first facial image against one or more second presentations of a facial image, the hardware and/or software for comparing one image against another may provide an indication of whether the compared images match identically. In other embodiments, upon comparing the first facial image against one or more second presentations of a facial image, the hardware and/or software for comparing one image against another may provide an indication of whether the compared images match substantially or nearly identically. In still other embodiments, upon comparing the first facial image against one or more second presentations of a facial image, the hardware and/or software for comparing one image against another may provide an indication of whether the compared images correspond or substantially correspond in a manner indicative that they are, for example, probably, likely, or highly likely to be images of the same face. In further embodiments, the hardware and/or software for comparing one image against another may provide an indicator 210 of the confidence level that the images are of the same face. The indicator 210 of the confidence level may be provided in any suitable format, such as but not limited to, a numerical value in a predetermined range (such as from 1-10 or other suitable numerical range), a percentage, a grade (such as from A-F), etc. In some embodiments, the hardware and/or software for comparing one image against another may consider or weigh any number or combination of various factors in providing the confidence level indicator 210. Such factors may include, but are not limited to, the desired speed at which the indicator is to be provided, the desired accuracy for a given use case or purpose, etc.

A method 300 according to the present disclosure may include a step 302 of capturing or receiving a first image from a person whose identity is to be verified or from another source on behalf of the person whose identity is to be verified. The first image may comprise an image resulting from a pattern of perforations, as described above. Prior to, substantially simultaneously with, or subsequent to receiving a first image, another or second presentation of an image may be provided in step 304. As described above, the second presentation of an image may be provided in any suitable format and come from any suitable source, such as the person whose identity is to be verified, a live feed, a database of images, etc. In step 306, one or more electronic devices, such as electronic device 102, server 114, or any combination of electronic device 102 and one or more servers 114, may recognize or identify one or more facial images in the first image, second presentation of an image, or both. In step 308, an electronic device, such as electronic device 102, server 114, or any combination of electronic device 102 and one or more servers 114, may compare two or more identified facial images. In some embodiments, a selection of which facial images to compare may be provided by the user, while in other embodiments, selection of the facial images for comparison may be automatically determined. In step 310, an indication of the confidence level that the compared facial images are of the same face may be provided by and/or at electronic device 102, server 114, or any combination of electronic device 102 and one or more servers 114.

Using images comprised of a pattern of perforations formed in a substrate, such as ImagePerf®, increases the likelihood that a credential is not fraudulent since the perforations are hard to create. However, human observation, alone, of the perforated image injects subjectivity. The various embodiments of the present disclosure advantageously decrease or remove the subjectivity in the comparison of an image, such as a facial image, resulting from a pattern of perforations against another image, such as a second facial image, and can advantageously increase the accuracy and speed in identity verification processes, particularly those out in the field.

For purposes of the present disclosure, any device or system described herein, such as, for example, electronic device 102 or server 114, may include any instrumentality or combination of instrumentalities operable to compute, determine, classify, process, transmit, receive, retrieve, store, display, communicate, detect, record, reproduce, handle, or utilize any form of information, intelligence, or data for business, scientific, control, or other purposes. For example, such device or system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices. Such device or system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RANI, such as static RAM for caching data.

Additional components of such device or system may include one or more disk drives or one or more mass storage devices, one or more input and output (I/O) devices, and one or more network ports for communicating with these devices or external devices. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. Such device or system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc.

A device or system of the present disclosure may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

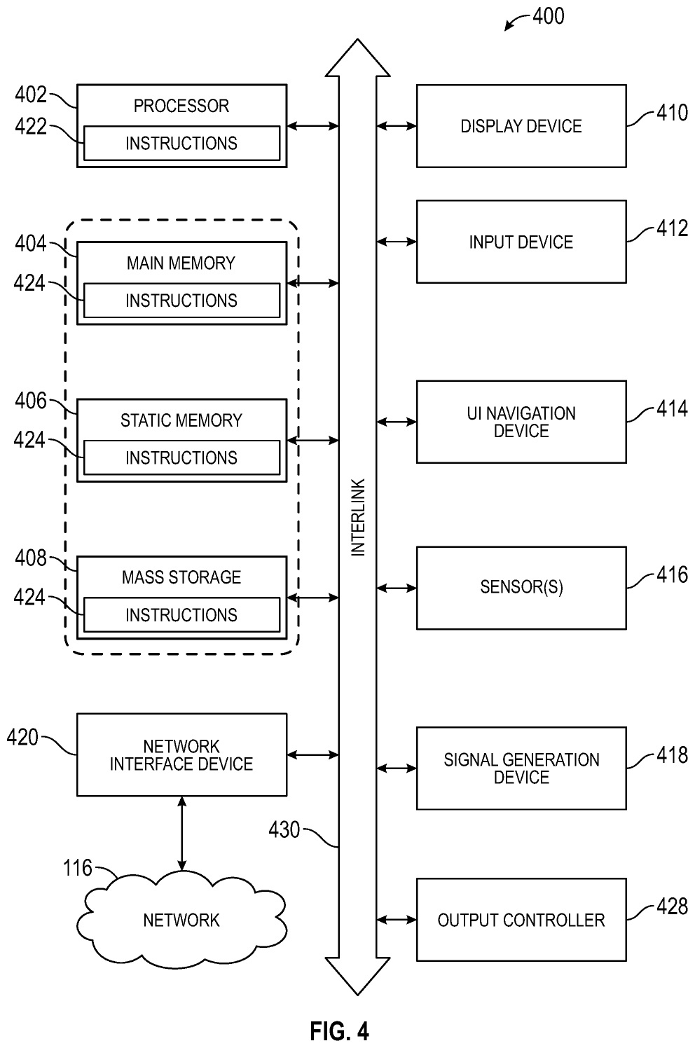

More specifically, FIG. 4 illustrates a block diagram schematic of various example components of an example machine 400 that can be used as any device or system described herein, such as, for example, electronic device 102 or server 114. In general, an example machine 400, as described herein, can include, or can operate by, logic or a number of components, or mechanisms in machine. Generally, circuitry (e.g., processing circuitry) is a collection of circuits implemented in tangible entities of machine 400 that include hardware (e.g., simple circuits, gates, logic, etc.). Circuitry membership can be flexible over time. Circuitries include members that can, alone or in combination, perform specified operations when operating. In some examples, hardware of the circuitry can be immutably designed to carry out a specific operation (e.g., hardwired). In some examples, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions permit embedded hardware (e.g., the execution units or a loading mechanism) to create members of the circuitry in hardware via the variable connections to carry out portions of the specific operation when in operation. Accordingly, in some examples, the machine readable medium elements are part of the circuitry or are communicatively coupled to the other components of the circuitry when the device is operating. In some examples, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional and/or more specific examples of components with respect to machine 400 follow.

In some embodiments, machine 400 can operate as a standalone device or can be connected (e.g., networked) to other machines. In a networked deployment, machine 400 can operate in the capacity of a server machine, a client machine, or both in server-client network environments. In some examples, machine 400 can act as a peer machine in a peer-to-peer (P2P) (or other distributed) network environment. Machine 400 can be or include a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 400 can include a hardware processor 402 (e.g., a central processing unit (CPU), a graphics processing unit (GPU), a hardware processor core, or any combination thereof) and a main memory 404, a static memory (e.g., memory or storage for firmware, microcode, a basic-input-output (BIOS), unified extensible firmware interface (UEFI), etc.) 406, and/or mass storage 408 (e.g., hard drives, tape drives, flash storage, or other block devices) some or all of which can communicate with each other via an interlink (e.g., bus) 430. Machine 400 can further include a display device 410 and an input device 412 and/or a user interface (UI) navigation device 414. Example input devices and UI navigation devices include, without limitation, one or more buttons, a keyboard, a touch-sensitive surface, a stylus, a camera, a microphone, etc.). In some examples, one or more of the display device 410, input device 412, and UI navigation device 414 can be a combined unit, such as a touch screen display. Machine 400 can additionally include a signal generation device 418 (e.g., a speaker), a network interface device 420, and one or more sensors 416, such as a global positioning system (GPS) sensor, compass, accelerometer, or other sensor. Machine 400 can include an output controller 428, such as a serial (e.g., universal serial bus (USB), parallel, or other wired or wireless (e.g., infrared (IR), NFC, etc.) connection to communicate or control one or more peripheral devices (e.g., a printer, card reader, etc.).

Processor 402 can correspond to one or more computer processing devices or resources. For instance, processor 402 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 402 can be provided as a microprocessor, Central Processing Unit (CPU), or plurality of microprocessors or CPUs that are configured to execute instructions sets stored in an internal memory 422 and/or memory 404, 406, 408.

Any of memory 404, 406, and 408 can be used in connection with the execution of application programming or instructions by processor 402, and for the temporary or long-term storage of program instructions or instruction sets 424 and/or other data. Any of memory 404, 406, 408 can comprise a computer readable medium that can be any medium that can contain, store, communicate, or transport data, program code, or instructions 424 for use by or in connection with machine 400. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), a solid-state storage device, in general, a compact disc read-only memory (CD-ROM), or other optical or magnetic storage device. Computer readable media includes, but is not to be confused with, computer readable storage media, which is intended to cover all physical, non-transitory, or similar embodiments of computer readable media.

Network interface device 420 includes hardware to facilitate communications with other devices over a communication network, such as communication channel 116, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 420 can include an Ethernet port or other physical jack, a Wi-Fi card, a Network Interface Card (MC), a cellular interface (e.g., antenna, filters, and associated circuitry), or the like. In some examples, network interface device 420 can include a plurality of antennas to wirelessly communicate using at least one of single-input multiple-output (SIMO), multiple-input multiple-output (MIMO), or multiple-input single-output (MISO) techniques.

As indicated above, machine 400 can include one or more interlinks or buses 430 operable to transmit communications between the various hardware components of the machine. A system bus 430 can be any of several types of commercially available bus structures or bus architectures.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure or portions thereof may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RANI), a read-only memory (ROM), an erasable programmable read-only memory (EPROM or Flash memory), a compact disc read-only memory (CD-ROM), or other optical, magnetic, or solid state storage device. Computer-readable media includes, but is not to be confused with, computer-readable storage medium, which is intended to cover all physical, non-transitory, or similar embodiments of computer-readable media.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A method for identity verification, the method comprising:
receiving an image of an identification document at an electronic device;
identifying, by the electronic device, a first facial image in the image of the identification document, the first facial image resulting from a pattern of perforations formed in a substrate of the identification document;
receiving a presentation of a second image at the electronic device;
identifying, by the electronic device, a second facial image in the second image;
comparing, by the electronic device, the first facial image and the second facial image; and
providing an indicator of a confidence level that the first facial image and second facial image are of a same face.

2. The method of claim 1, wherein the image of the identification document is received via a camera feature of the electronic device.

3. The method of claim 1, wherein at least one of:
the presentation of the second image is received via a camera feature of the electronic device;
the second image is a photograph displayed on a display of the electronic device; or
the second image is a live feed displayed on a display of the electronic device.

4-5. (canceled)

6. The method of claim 1, wherein the presentation of the second image is received from a remote database storing a plurality of images.

7. The method of claim 1, wherein the second facial image is an encoded facial image.

8. The method of claim 7, wherein the encoded facial image is a two-dimensional barcode.

9. The method of claim 7, wherein comparing the first facial image and the second facial image comprises at least one of:
encoding the first facial image and comparing the encoded first facial image with the second facial image; or
decoding the second facial image and comparing the first facial image with the decoded second facial image.

10. The method of claim 1, further comprising:
receiving a presentation of a third image at the electronic device;
identifying, by the electronic device, a third facial image in the third image; and
comparing, by the electronic device, the first facial image and the third facial image.

11. The method of claim 10, wherein providing an indicator of a confidence level comprises providing an indicator of a confidence level that the first facial image is of the same face as the second facial image and third facial image.

12. The method of claim 11, wherein at least one of:
the presentation of the third image is received via a camera feature of the electronic device;
the third image is a photograph displayed on a display of the electronic device; or
the third image is a live feed displayed on a display of the electronic device.

13-14. (canceled)

15. The method of claim 11, wherein the presentation of the third image is received from a remote database storing a plurality of images.

16. The method of claim 1, wherein:
the electronic device comprises two or more electronic devices communicatively coupled to one another;
the step of receiving an image of an identification document is performed by a first one of the electronic devices; and
the step of comparing the first facial image and the second facial image is performed by a second one of the electronic devices; and
further comprising providing, by the second one of the electronic devices to the first one of the electronic devices, results of the step of comparing the first facial image and the second facial image.

17-18. (canceled)

19. A method for identity verification, the method comprising:
receiving an image of an identification document at an electronic device;
identifying, by the electronic device, a first facial image and a second facial image in the image of the identification document, the first facial image resulting from a pattern of perforations formed in a substrate of the identification document;
comparing, by the electronic device, the first facial image and the second facial image; and
providing an indicator of a confidence level that the first facial image and second facial image are of a same face.

20. The method of claim 19, wherein the second facial image is a photograph printed or engraved on the identification document.

21. The method of claim 20, wherein the image of the identification document is received via a camera feature of the electronic device.

22. The method of claim 20, further comprising:
receiving a presentation of a third image at the electronic device;
identifying, by the electronic device, a third facial image in the third image; and
comparing, by the electronic device, the first facial image and the third facial image.

23. The method of claim 22, wherein providing an indicator of a confidence level comprises providing an indicator of a confidence level that the first facial image is of the same face as the second facial image and third facial image.

24. The method of claim 23, wherein at least one of:
the presentation of the third image is received via a camera feature of the electronic device;
the third image is a photograph displayed on a display of the electronic device; or
the third image is a live feed displayed on a display of the electronic device.

25-26. (canceled)

27. The method of claim 23, wherein the presentation of the third image is received from a remote database storing a plurality of images.

28. The method of claim 19, wherein:
the electronic device comprises two or more electronic devices communicatively coupled to one another;
the step of receiving an image of an identification document is performed by a first one of the electronic device; and
the step of comparing the first facial image and the second facial image is performed by a second one of the electronic devices; and
further comprising providing, by the second one of the electronic devices to the first one of the electronic devices, results of the step of comparing the first facial image and the second facial image.

29-30. (canceled)

31. A non-transitory computer readable medium comprising executable program code, that when executed by one or more processors, causes the one or more processors to carry out the steps of:
receiving an image of an identification document;
identifying a first facial image in the image of the identification document, the first facial image resulting from a pattern of perforations formed in a substrate of the identification document;
receiving a presentation of a second image;
identifying a second facial image in the second image;
comparing the first facial image and the second facial image; and
providing an indicator of a confidence level that the first facial image and second facial image are of a same face.
